(19) United States
(12) Patent Application Publication
(10) Pub. No.: US 2026/0303588 A1
(43) Pub. Date: Oct. 1, 2026

(54) COMMUNICATION DEVICE AND NON-TRANSITORY COMPUTER-READABLE RECORDING MEDIUM STORING COMPUTER-READABLE INSTRUCTIONS FOR COMMUNICATION DEVICE

(71) Applicant: BROTHER KOGYO KABUSHIKI KAISHA, Nagoya (JP)

(72) Inventors: Akihito UNO, Iwakura (JP); Yutaka URAKAWA, Nagoya (JP)

(21) Appl. No.: 19/631,212

(22) Filed: Mar. 27, 2026

(30) Foreign Application Priority Data
Mar. 31, 2025 (JP) 2025-059421

(51) Int. Cl. H04L 9/40

(52) U.S. Cl. CPC H04L 63/083

(57) ABSTRACT

A communication device may include: a memory configured to store data which is to be sent; and a controller configured to: in a case where a first user authentication is successful in a server on the Internet, receive a first token from the server, the first token being created in response to success of the first user authentication and being stored in the server in association with a first user identifier which was used in the first user authentication; send to the server a first address request including the first token to receive a first email address from the server as a response to the first address request, the first email address being stored in the server in a state of being obtainable using the first token; and send the data in the memory using the first email address received from the server as a recipient.

### REFERENCE TO RELATED APPLICATIONS

This application claims priority from Japanese Patent Application No. 2025-059421 filed on Mar. 31, 2025. The entire content of the priority application is incorporated herein by reference.

### BACKGROUND

An image forming device including an address book storage is known. When authentication of an operator operating the image forming device succeeds, the image forming device sends image data, using an address stored in the address book storage as a recipient.

This specification provides a technique for sending data using an email address stored in a server on the Internet as a recipient.

### SUMMARY

A communication device disclosed herein may include: a memory configured to store data which is to be sent; and a controller configured to: in a case where a first user authentication is successful in a server on the Internet, receive a first token from the server, the first token being created in response to success of the first user authentication and being stored in the server in association with a first user identifier which was used in the first user authentication; send to the server a first address request including the first token to receive a first email address from the server as a response to the first address request, the first email address being stored in the server in a state of being obtainable using the first token; and send the data in the memory, using the first email address received from the server as a recipient.

According to the above configuration, the first token is received from the server when the first user authentication at the server is successful. The communication device can access information stored in the server by using the first token. The communication device can receive an email address stored in the server by using the first token. The communication device then sends the data to be sent, using the email address received from the server as its recipient. The communication device can send data, using an email address stored in a server on the Internet as its recipient.

A non-transitory computer-readable recording medium storing computer-readable instructions for the above-described communication device is also novel and useful. A communication system comprising the communication device described above and a method of controlling the communication device described above are also novel and useful.

### BRIEF DESCRIPTION OF DRAWINGS

FIG. 1 is a block diagram of a communication system.

FIG. 2 is a sequence diagram of process of issuing a token.

FIG. 3 is continuation of FIG. 2.

FIG. 4 is a sequence diagram of process of searching for a recipient of data.

FIG. 5 is a sequence diagram of process of sending data individually.

### DESCRIPTION

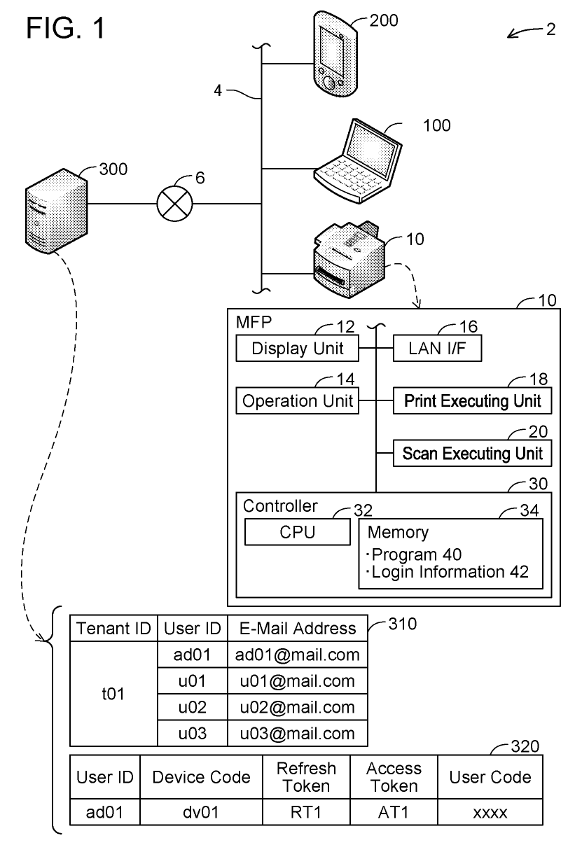

### Configuration of Communication System 2; FIG. 1

A communication system 2 comprises an MFP 10, an administrator terminal 100, a user terminal 200, and a server 300. The MFP 10 is a device with multiple functions including printing and scanning functions. “MFP” stands for a Multifunction Peripheral. The administrator terminal 100 and the user terminal 200 may be laptop PCs, desktop PCs, tablet terminals, smartphones, etc.

The MFP 10, the administrator terminal 100, and the user terminal 200 are used in a specific organization. The specific organization may be, for example, a corporation, an office, a department within a company, etc. The administrator terminal 100 is a terminal device used by an administrator belonging to the specific organization. The user terminal 200 is a terminal device used by a user who belongs to the specific organization and is managed by the administrator. Here, the specific organization has one or more users for one administrator. Therefore, there may be multiple user terminals 200 in the specific organization.

The MFP 10, the administrator terminal 100, and the user terminal 200 are connected to a LAN 4. “LAN” stands for Local Area Network. The LAN 4 may be wireless or wired. The administrator terminal 100 and the user terminal 200 are configured to communicate with the MFP 10 via the LAN 4.

The LAN 4 is connected to the Internet 6. The devices connected to the LAN 4, e.g., MFP 10, can communicate with the server 300 via the Internet 6 and LAN 4.

### Configuration of MFP 10; FIG. 1

The MFP 10 comprises a display unit 12, an operation unit 14, a LAN interface 16, a print executing unit 18, a scan executing unit 20, and a controller 30. In the following, “interface” may be described as “I/F”.

The display unit 12 is a display or panel for showing various information. The panel may or may not be a touch panel. The panel may be, for example, an LCD panel or an OLED panel. The operation unit 14 is a user interface that allows the user to input various types of information to the MFP 10. The operation unit 14 comprises, for example, software key(s), i.e., a touch panel for displaying operation object(s), hardware key(s), or both. The hardware key(s) are, for example, button(s), switch(es), etc.

The LAN I/F 16 is an interface for communication via the LAN 4. The LAN I/F 16 is connected to the LAN 4. The print executing unit 18 is hardware configured to print on a print medium in accordance with print data. The print executing unit 18 is realized, for example, by an inkjet method and/or an electrophotographic method. The scan executing unit 20 is hardware configured to scan a document. The scan executing unit 20 comprises a scanner engine that has an image sensor such as a Charge-Coupled Device (CCD) or Contact Image Sensor (CIS).

The controller 30 comprises a CPU 32 and a memory 34. The memory 34 comprises a main storage and an auxiliary storage. Although this is an example, the main storage includes RAM and cache memory. Although this is an example, the auxiliary storage device may be ROM, flash memory, Solid State Drive (SSD), Hard Disk Drive (HDD), or a combination thereof. The CPU 32 performs various processes according to the program 40 loaded from the auxiliary storage to the main storage.

The MFP 10 has a server function that provides a setting screen for changing settings of the MFP 10. The memory 34 stores login information 42 for logging into a server function of the MFP 10. The login information 42 is, for example, a user name and password.

### Configuration of Server 300; FIG. 1

The server 300 provides a service which manages accounts of users belonging to an organization. The service is, for example, Microsoft Entra ID (registered trademark). The server 300 stores an account table 310 and a token table 320.

The account table 310 manages information about users belonging to an organization. The account table 310 stores a tenant ID, a user ID, and an email addresses in association with each other. The tenant ID is an identifier that identifies the organization. The user ID is an identifier that identifies the user. The user ID is a so-called account name. Although not shown in the figures, each user ID is stored with a password in association therewith. For example, as shown in FIG. 1, one tenant ID “t01” is associated with four user IDs “ad01”, “u01”, “u02”, and “u03”. Here, the user ID “ad01” identifies the administrator who belongs to the specific organization identified by the tenant ID “t01”. Each of user IDs “u01”, “u02”, and “u03” identifies a user other than the administrator who belongs to the specific organization identified by the tenant ID “t01”. In the following, the user ID identifying the administrator will be described as an administrator ID. The user ID that identifies a user other than the administrator will be described as an individual user ID.

In this embodiment, the administrator ID “ad01” is stored in association with administrator privilege information that indicates privilege(s) of the administrator. The administrator privilege information indicates the privilege to access all email address(es) stored in association with the tenant ID “t01”. The individual user ID is also stored in association with individual privilege (i.e., individual authorization) information indicating privilege(s) of the user (i.e., authorization given to the user) identified by that individual user ID. The individual privilege information indicates the privilege to access the email address stored in association with the corresponding individual user ID. On the other hand, the individual privilege information does not indicate the privilege to access the email address(es) stored in association with other user ID(s). In a modification, the individual privilege information may indicate the privilege to access multiple email addresses. For example, the individual privilege information corresponding to the individual user ID “u01” may indicate the privilege to access not only the email address(es) stored in association with the individual user ID “u01” but also the email address(es) stored in association with another user ID “u02”.

The token table 320 manages token(s). Token(s) are authentication information issued by the server 300. The token table 320 stores a user ID, a device code, a refresh token, an access token, and a user code in association with each other. The device code is a code assigned to a device such as the MFP 10. The user code is a code assigned to a user. The access token is authentication information for enabling the privilege indicated by the administrator privilege information or individual privilege information stored in association with the corresponding user ID. The access token is a token that has a predetermined expiration. The refresh token is a token for updating the access token. In a modification, the access token may not have an expiration date.

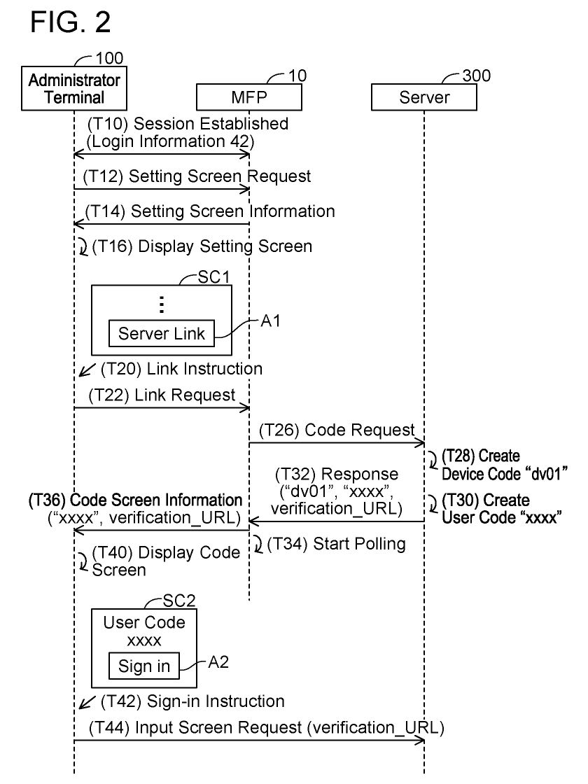

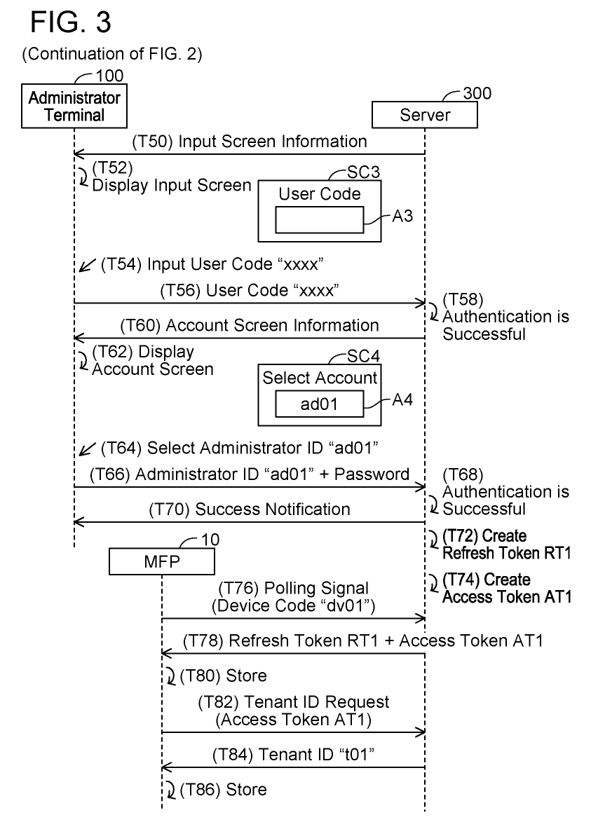

### Process of Issuing Token; FIGS. 2 and 3

With reference to FIGS. 2 and 3, process of issuing a token will be described. In the following description, process executed by the MFP 10 is realized by the CPU 32 of the MFP 10, which operates according to the program 40. Communication between devices is executed via the LAN 4, the Internet 6, and the LAN I/F 16. In the following, when communication between devices is described, descriptions of the LAN 4, the Internet 6, and the LAN I/F 16 will be omitted.

In T10, the administrator terminal 100 logs into the server function of the MFP 10 using the login information 42. Due to this, a login session is established between the administrator terminal 100 and the MFP 10. In the following process, the login session is used for communication between the administrator terminal 100 and the MFP 10.

In T12, the administrator terminal 100 sends a setting screen request for requesting setting screen information to the MFP 10. The setting screen information is information corresponding to a setting screen SC1 for changing the settings of the MFP 10.

In T14, the administrator terminal 100 receives the setting screen information from the MFP 10 as a response to the setting screen request in T12. In T16, the administrator terminal 100 displays the setting screen SC1. The setting screen SC1 includes a plurality of icons corresponding to various settings of the MFP 10. The setting screen SC1 includes an icon A1 that receives an instruction to start a linkage with the server 300 from the user.

When the administrator terminal 100 detects selection of the icon A1 in the setting screen SC1 in T20, the administrator terminal 100 sends a link request to the MFP 10 in T22. The link request is a signal for requesting to start a link with the server 300.

When the MFP 10 receives the link request from the administrator terminal 100 in T22, the MFP 10 sends a code request to the server 300 in T26. The code request is a signal for requesting a device code and a user code.

When the server 300 receives the code request from the MFP 10 in T26, the server 300 creates the device code “dv01” in T28. Furthermore, the server 300 creates a user code “xxxx” in T30. The server 300 stores the user code “xxxx” in the token table 320 in association with the device code “dv01”.

In T32, the server 300 sends a response to the code request to the MFP 10. The response includes the device code “dv01” created in T28, the user code “xxxx” created in T30, and a ‘verification_URL’. The ‘verification_URL’ is a URL for accessing input screen information corresponding to an input screen SC3 for inputting the user code. FIG. 3 shows an example of the input screen SC3.

When the MFP 10 receives the response from the server 300 in T32, the MFP 10 starts repeatedly sending polling signals to the server 300 in T34. The polling signal is a signal to confirm that a token has been issued. The polling signal includes the device code “dv01” received in T32.

In T36, the MFP 10 sends code screen information corresponding to a code screen SC2 which displays the user code to the administrator terminal 100. The code screen information includes the user code “xxxx” and the ‘verification_URL’.

When the administrator terminal 100 receives the code screen information from the MFP 10 in T36, the administrator terminal 100 displays the code screen SC2 in T40. The code screen SC2 includes a character string indicating the user code “xxxx” and an icon A2. The icon A2 is an icon that receives an instruction to sign in to the server 300 from the user.

When the administrator terminal 100 detects selection of the icon A2 in the code screen SC2 in T42, the administrator terminal 100 sends an input screen request to the server 300 in T44. The input screen request is a signal for requesting the input screen information and includes the ‘verification_URL’.

In T50 in FIG. 3, the administrator terminal 100 receives the input screen information as a response to the input screen request in T42. In T52, the administrator terminal 100 displays the input screen SC3. The input screen SC3 includes an input field A3 for inputting a user code.

In T54, the administrator terminal 100 detects the input of the user code “xxxx” in the input field A3. In T56, the administrator terminal 100 sends the user code “xxxx”, which had been inputted to the input field A3, to the server 300.

When the server 300 receives the user code “xxxx” from the administrator terminal 100 in T56, the server 300 authenticates the user code “xxxx” received from the administrator terminal 100. In this case, the user code “xxxx” received from the administrator terminal 100 matches the user code “xxxx” stored in the token table 320. Therefore, in T58, the authentication of the user code "xxxx" succeeds.

When the authentication of the user code “xxxx” succeeds, the server 300 sends account screen information to the administrator terminal 100 in T60. The account screen information corresponds to an account screen SC4 for selecting a target account name for which the token should be issued.

When the administrator terminal 100 receives the account screen information from the server 300 in T60, the administrator terminal 100 displays the account screen SC4 in T62. The account screen SC4 includes an icon A4 for selecting a target account name from the account name(s) stored in the administrator terminal 100. In this case, the administrator ID “ad01” is stored in the administrator terminal 100 as an account name. Due to this, the administrator ID “ad01” is displayed on the icon A4. If multiple account names are stored in the administrator terminal 100, multiple icons A4 are displayed on the account screen SC4. The account screen SC4 may also include an icon for creating a new account and an input field for entering a new account name and password. In this case, the administrator selects the icon A4 in the account screen SC4.

The administrator terminal 100 proceeds to T66 when detecting selection of the icon A4 in the account screen SC4 in T64. In T66, the administrator terminal 100 sends the administrator ID “ad01” corresponding to the icon A4 and the password to the server 300.

In T66, when the server 300 receives the administrator ID “ad01” and the password from the administrator terminal 100, the server 300 authenticates the administrator ID “ad01” and the password. In this case, the administrator ID “ad01” and the password are stored in the account table 310. Due to this, in T68, the authentication of the administrator ID “ad01” and password succeeds. The successfully authenticated administrator ID “ad01” is stored in the token table 320 in association with the user code “xxxx” and the device code “dv01”.

When the authentication of the administrator ID “ad01” and the password succeeds in T68, the server 300 proceeds to T70. In T70, the server 300 sends a success notification indicating that the authentication was successful to the administrator terminal 100. Further, in T72, the server 300 creates a refresh token RT1. In the subsequent T74, the server 300 creates an access token AT1 based on the refresh token RT1. The server 300 then stores the tokens RT1 and AT1 in the token table 320 in association with the administrator ID “ad01” and the device code “dv01”.

Between T36 in FIG. 2 and T74 in FIG. 3, the MFP 10 repeatedly sends polling signals including the device code “dv01” to the server 300. In T76, the server 300 receives a polling signal from the MFP 10 after the tokens RT1 and AT1 have been created. In T78, the server 300 sends the tokens RT1 and AT1, which are stored in association with the device code “dv01” included in the polling signal, to the MFP 10.

When the MFP 10 receives the tokens RT1 and AT1 from the server 300 in T78, the MFP 10 stores the tokens RT1 and AT1 in the memory 34 in T80.

In the following T82, the MFP 10 sends a tenant ID request for requesting a tenant ID to the server 300. The tenant ID request includes the access token AT1.

The server 300 receives the tenant ID request from the administrator terminal 100 in T82 and proceeds to T84. The server 300 identifies the management identifier “ad01” stored in association with the access token AT1 within the tenant ID request from the token table 320 in T84. The server 300 then sends the tenant ID “t01” stored in the account table 310 in association with the identified management identifier “ad01” to the administrator terminal 100.

The MFP 10 receives the tenant ID “t01” from the server 300 in T84, and stores the tenant ID “t01” in the memory 34 in T86.

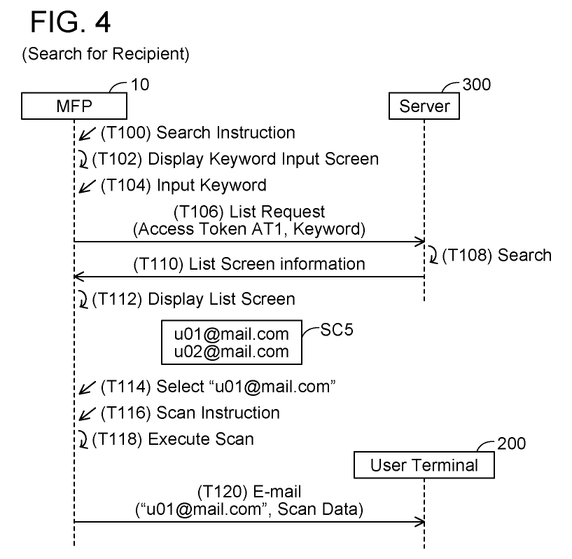

### Process of Searching for Recipient for Data; FIG. 4.

The process in FIG. 4 is for searching for an email address of a user who belongs to a specific organization identified by the tenant ID “t01”. The process in FIG. 4 can be executed after the process in FIGS. 2 and 3.

The user inputs a search instruction to the operation unit 14 of the MFP 10 in T100. The search instruction is an instruction to search for an email address.

When the MFP 10 detects the input of the search instruction in T100, the MPF 10 proceeds to T102. In T102, the MFP 10 displays a keyword input screen on the display unit 12 for inputting a keyword to be used for the search for the email address.

When the MFP 10 detects the input of the keyword to the keyword input screen in T104, the MFP 10 proceeds to T106. In T106, the MFP 10 sends a list request which requests a list of email address(es) to the server 300. The list request includes the access token AT1 stored in the memory 34 and the keyword entered in T104.

When the server 300 receives the list request from the MFP 10 in T106, the server 300 proceeds to T108. In T108, the server 300 identifies the administrator ID “ad01” stored in association with the access token AT1 included in the list request from the token table 320. The server 300 identifies the tenant ID “t01” stored in association with the identified administrator ID “ad01” from the account table 310. The server 300 identifies a plurality of email addresses stored in association with the identified tenant ID “t01” from the account table 310. The server 300 then identifies one or more email addresses that contain the keyword included in the list request from among the identified plurality of email addresses. This results in the one or more email addresses that contain the keyword included in the list request being searched.

In the following T110, the server 300 sends list screen information corresponding to a list screen SC5 to the administrator terminal 100 as a response to the list request of T106. The list screen information includes the one or more email addresses searched in T108.

When the MFP 10 receives the list screen information in T110, the MFP 10 displays the list screen SC5 in T112. The list screen SC5 includes a list of the one or more email addresses included in the list screen information.

When the MFP 10 detects the selection of one email address in the list screen SC5 in T114, the MFP 10 displays a scan screen on the display unit 12. The scan screen is a screen for inputting scanning settings and an instruction to execute a scan.

When the MFP 10 detects the input of the instruction to execute a scan on the scan screen in T116, the MFP 10 proceeds to T118. In T118, the MFP 10 causes the scan executing unit 120 to execute a scan of the document. This creates scan data to be sent.

In T120, the MFP 10 creates an email with the scan data created in T118 attached. The MFP 10 then sends the created email, using the email address selected in T114 as the recipient.

According to this configuration, the MFP 10 can receive a list of email address(es) from the server 300 on the Internet 6 (T110 in FIG. 4). Then, the MFP 10 can send the scan data, using the email address in the list as the recipient (T120). In particular, through the process in FIGS. 2 and 3, authentication of the administrator ID “ad01” is performed in advance, and the access token AT1 corresponding to the administrator ID “ad01” is stored in the MFP 10. Since it is not necessary to authenticate the administrator ID “ad01” each time an email address is searched, user convenience can be improved.

The list of email address(es) including the keyword inputted by the user is received (T110). Compared to a comparative example in which all email addresses are received, the user can easily find an email address. User convenience can be improved. In a modification, the configuration of the comparative example above may be adopted.

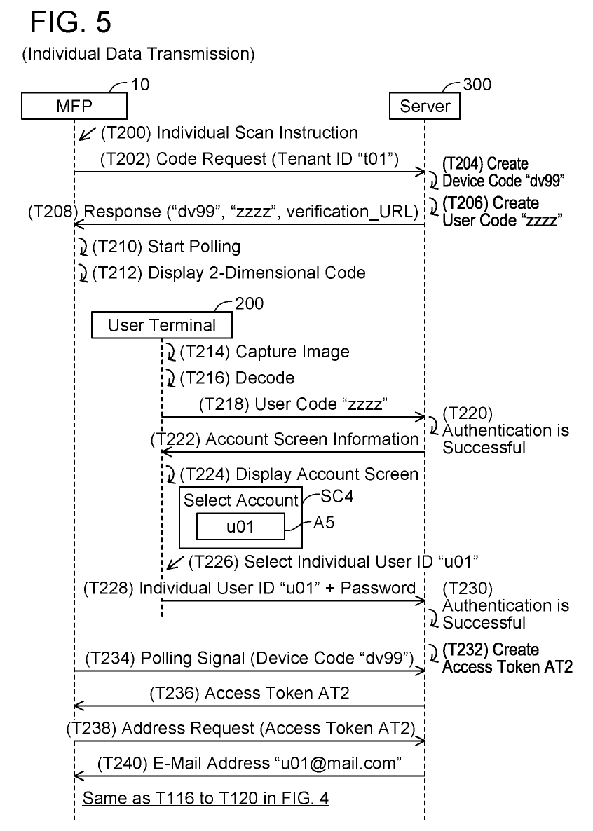

### Process of Sending Data Individually; FIG. 5

The process in FIG. 5 is for each user belonging to a specific organization to send scan data to the email address corresponding to each user. The process in FIG. 5 can be executed after the process in FIGS. 2 and 3.

The user inputs an individual scan instruction to the operation unit 14 of the MFP 10 in T200. The individual scan instruction is an instruction to send scan data to the email address corresponding to the user actually operating the MFP 10. The process executed in accordance with the individual scan instruction does not include a search for the email address.

When the MFP 10 detects the input of the individual scan instruction in T200, the MFP 10 proceeds to T202. In T202, the MFP 10 sends a code request including the tenant ID “t01” stored in the memory 34 to the server 300. The code request in T202 is the same as the code request in T26 in FIG. 2, except that it includes the tenant ID “t01”.

Process of T204 and T206 are similar to T28 and T30 in FIG. 2, except that the device code “dv99” and the user code “zzzz” are created. T208 and T210 are the same as T32 and T34 in FIG. 2, except that the device code “dv99” and the user code “zzzz” are used.

In the following T212, the MFP 10 displays a two-dimensional code on the display unit 12. The two-dimensional code is an image encoded with the ‘verification_URL’ and the user code “zzzz” received from the server 300.

In T214, the user operates the user terminal 200 to capture the two-dimensional code displayed in T212. Due to this, in T216, the user terminal 200 decodes the two-dimensional code and obtains the ‘verification_URL’ and the user code “zzzz”.

In T218, the user terminal 200 sends the user code “zzzz” to the server 300 using the ‘verification_URL’.

When the server 300 receives the user code “zzzz” from the user terminal 200 in T218, the server 300 authenticates the user code “zzzz” received from the user terminal 200. In this case, the user code “zzzz” received from the user terminal 200 matches the user code “zzzz” stored in the token table 320. Due to this, in T220, the authentication of the user code “zzzz” succeeds.

When the user code “zzzz” succeeds, the server 300 sends the account screen information to the user terminal 200 in T222.

When the user terminal 200 receives the account screen information from the server 300 in T222, the user terminal 200 displays the account screen SC4 in T224. In this case, the individual user ID “u01” is stored in the user terminal 200 as an account name. The account screen SC4 includes an icon A5 on which the individual user ID “u01” is displayed.

When the user terminal 200 detects selection of the icon A5 in the account screen SC4 in T226, the user terminal 200 proceeds to T228. In T228, the user terminal 200 sends the individual user ID “u01” corresponding to the icon A5 and the password to the server 300.

When the server 300 receives the individual user ID “u01” and password from the user terminal 200 in T228, the server 300 authenticates the individual user ID “u01” and password. In this case, the individual user ID “u01” and password are successfully authenticated in T230. The individual user ID “u01” that has been successfully authenticated is stored in association with the device code “dv99” and stored in the token table 320. Next, the server 300 creates the access token AT2, and stores the access token AT2 in the token table 320 in association with the device code “dv99”.

The access token AT2 has the privilege (authorization) to access the email address stored in association with the individual user ID “u01”. However, the access token AT2 does not have the privilege to access email address(es) other than the email address stored in association with the individual user ID “u01”. Contrary to this, the access token AT1 created in T74 in FIG. 3 has the privilege to access all the email addresses stored in association with the tenant ID “t01”. This is because the access token AT1 is associated with the administrator ID “ad01” and the administrator ID “ad01” has the privilege to access all the email addresses.

In T234, the server 300 receives a polling signal from the MFP 10 after the access token AT2 has been created. In T236, the server 300 sends the access token AT2 stored in association with the device code “dv99” included in the polling signal to the MFP 10.

In the following T238, the server 300 sends an address request which requests an email address to the server 300. The address request includes the access token AT2.

When the server 300 receives the address request from the user terminal 200 in T238, the server 300 proceeds to T240. In T240, the server 300 identifies the individual user ID “u01” stored in association with the access token AT2 in the address request from the token table 320. The server 300 then sends the email address(es) stored in the account table 310 in association with the identified individual user ID “u” to the user terminal 200.

In T240, the user terminal 200 receives the email address(es) corresponding to the individual user ID “u01” from the server 300. Then, the user terminal 200 executes the same process as T116 to T120 in FIG. 4 using the email address(es) corresponding to the individual user ID “u01”. The process from T200 to T240 is executed each time the individual scan instruction is inputted.

According to the above configuration, in addition to the authentication using the administrator ID according to FIGS. 2 and 3, authentication using the individual user ID is executed (T230 in FIG. 5). This allows the MFP 10 to obtain the email address(es) stored in association with the individual user ID from the server 300. The user corresponding to the individual user ID does not have to search for the email address(es). User convenience can be improved.

The authentication using the individual user ID is initiated by the code request including the tenant ID “t01” as its trigger. The tenant ID “t01” is obtained using the access token AT1 corresponding to the administrator ID (T84 in FIG. 2). That is, the process in FIG. 5, such as obtaining an email addresses individually, is executed on conditions of both the authentication using the administrator ID and the authentication using the individual user ID.

### Effects of Present Embodiment

The process in FIGS. 4 and 5 allow the MFP 10 to obtain the email address(es) from the server 300 on the Internet 6. Then, the MFP 10 can send scan data, using the email address(es) obtained from the server 300 as its recipient.

The process in FIG. 4 is also executed using the access token AT1. the MFP 10 updates the access token AT1 using the refresh token RT1 when the access token AT1 expires. By the access token AT1 being periodically updated, it is possible to both ensure the convenience of omitting authentication using a user ID and ensure security.

### Correspondence Relationships

The scan data is an example of "data which to be sent." The MFP 10, the display unit 12, the scan executing unit 20, and the memory 34 are respectively an example of "communication device," "display unit" "scan executing unit," and "memory." The server 300 is an example of "server". FIGS. 2 and 3 are examples of "first user authentication". The access token AT1 and the administrator ID "ad01" are an example of "first token" and "first user identifier", respectively. The user code "xxxx", the device code "dv01", and the polling signal of T34 in FIG. 2 are an example of "user code", "device code", and "signal", respectively. The list request of T106 and the list of T112 in FIG. 4 are an example of "first address request" and "list", respectively. The email address corresponding to the administrator ID "ad01" is an example of "first email address". The access token AT2, the individual user ID "u01", and the tenant ID "t01" are examples of "second token", "second user identifier", and "organization identifier", respectively. The code request and user terminal 200 in T202 in FIG. 5 are an example of "start instruction" and "terminal device," respectively.

T78 in FIG. 3 is an example of process realized by “receive a first token from the server”. T110 and T120 in FIG. 4 are an example of a process realized by “send to the server a first address request including the first token to receive a first email address” and “send the data in the memory”, respectively.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modification 1

The process shown in FIG. 4 may not be executed, but the process shown in FIG. 5 may be executed. In this modification, “list” is omitted. In this modification, the access token AT2 and the individual user ID “u01” are respectively an example of “first token” and the “first user identifier”. In addition, T236 and T240 in FIG. 5 are an example of process realized by “receive a first token from the server”, “send to the server a first address request including the first token to receive a first email address”.

### Modification 2

The process shown in FIG. 5 may not be performed but the process shown in FIG. 4 may be performed. In this modification, the “second token” is omitted.

### Modification 3

In T212 in FIG. 5, the user code “zzzz” may be displayed and the user code “zzzz” may be sent using wireless communication such as NFC. In this modification, the displaying or sending of the above user code “zzzz” is an example of “output the user code”.

### Modification 4

The “communication device” is not limited to the MFP 10, but may be a scanner, printer, or other terminal device. In other words, “data which is to be sent” is not limited to scan data, but may be other image data, document data, voice data, etc.

### Modification 5

In the above embodiment, each process in FIGS. 2 through 5 is realized by the CPU 32 executing the program 40. Instead of these, any of the process may be realized by hardware such as logic circuitry.

What is claimed is:

1. A communication device comprising:
a memory configured to store data which is to be sent; and
a controller configured to:
in a case where a first user authentication is successful in a server on the Internet, receive a first token from the server, the first token being created in response to success of the first user authentication and being stored in the server in association with a first user identifier which was used in the first user authentication;
send to the server a first address request including the first token to receive a first email address from the server as a response to the first address request, the first email address being stored in the server in a state of being obtainable using the first token; and
send the data in the memory using the first email address received from the server as a recipient.

2. The communication device according to claim 1, wherein
the controller is configured to receive a list of one or more email addresses stored in the server in association with the first user identifier and including the first email address from the server,
the communication device further comprises a display unit,
the controller is further configured to cause the display unit to display the list received from the server, and
the controller is configured to send the data using the first email address selected by the user from among the list displayed on the display unit as a recipient.

3. The communication device according to claim 2, wherein
the first address request includes one or more keywords;
the controller is configured to receive, from the server, the list of one or more email addresses that include the one or more keywords included in the first address request, from among a plurality of email addresses stored in the server in association with the first user identifier.

4. The communication device according to claim 1, wherein
in the server, one or more user identifiers are stored in association with the first user identifier,
the controller is further configured to:
in a case where a second user authentication is successful in the server after the first token has been received, receive a second token different from the first token from the server, a second user identifier of the one or more user identifiers being used in the second user authentication, and the second token being created in response to success of the second user authentication and being stored in the server in association with the second user identifier;
send to the server a second address request including the second token to receive a second email address from the server as a response to the second address request, the second email address being stored in the server in a state of being obtainable using the second token; and
send the data in the memory, using the second email address received from the server as a recipient.

5. The communication device according to claim 4, wherein
an organization identifier is stored in the server, the organization identifier identifying an organization to which one or more users identified by the one or more user identifiers and a user identified by the first user identifier belong,
the controller is further configured to:
in response to receiving the first token from the server, send to the server an identifier request for requesting the organization identifier, the identifier request including the first token;
receive the organization identifier stored in the server in association with the first token included in the identifier request from the server; and
send to the server a start instruction for instructing to start the second user authentication, the start instruction including the organization identifier received from the server.

6. The communication device according to claim 4, wherein
the controller is configured to send to the server the first address request including the first token to receive a list of one or more email addresses stored in the server in association with the first user identifier and including the first email address from the server, and
the controller is configured to send to the server the second address request including the second token to receive only the second email address stored in the server in association with the second user identifier from the server.

7. The communication device according to claim 4, wherein
the first token has a privilege to access both the first email address and the second email address, and
the second token has a privilege to access the second email address but does not have a privilege to access the first email address.

8. The communication device according to claim 1, wherein
the controller is further configured to:
send to the server a code request for requesting a user code to receive the user code from the server; and
output the user code received from the server, and
the user code outputted from the communication device is obtained by a terminal device different from the communication device,
the obtained user code and the first user identifier are sent to the server by the terminal device, and
the first user authentication includes:
the server authenticating the user code received from the terminal device; and
the server authenticating the first user identifier received from the terminal device.

9. The communication device according to claim 8, wherein
the controller is further configured to:
receive a device code different from the user code from the server; and
start polling a signal including the device code in response to receiving the device code from the server, and
the controller is configured to, in a case where the signal is received by the server after the success of the first user authentication, receive the first token stored in the server in association with the device code included in the signal from the server as a response to the signal.

10. The communication device according to claim 1, wherein
the first token has an expiration.

11. The communication device according to claim 10, wherein
the controller is configured to receive a refresh token and the first token which is an access token from the server, and
the controller is further configured to, in a case where the expiration of the first token has elapsed, update the first token by using the refresh token.

12. The communication device according to claim 1, wherein
the communication device further comprises a scan executing unit, and
the data is image data created by the scan executing unit.

13. A non-transitory computer-readable recording medium storing computer-readable instructions for a communication device, wherein
the communication device comprises:
a memory configured to store data which is to be sent; and
a processor, wherein
the computer-readable instructions, when executed by the processor, cause the communication device to:
in a case where a first user authentication is successful in a server on the Internet, receive a first token from the server, the first token being created in response to success of the first user authentication and being stored in the server in association with a first user identifier which was used in the first user authentication;
send to the server a first address request including the first token to receive a first email address from the server as a response to the first address request, the first email address being stored in the server in a state of being obtainable using the first token; and
send the data in the memory using the first email address received from the server as a recipient.
